(19) United States
(12) Patent Application Publication
(10) Pub. No.: US 2006/0239158 A1
(43) Pub. Date: Oct. 26, 2006

(54) OPTICAL STORAGE DEVICE AND METHOD OF GENERATING TRACKING ERROR SIGNAL THEREIN

(76) Inventor: Chih-Sheng Wei, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 10/907,894

(22) Filed: Apr. 20, 2005

(51) Int. Cl. G11B 7/00

(52) U.S. Cl. 369/53.23

(57) ABSTRACT

An optical storage device capable of compensating for y-ratio misalignment when generating a tracking error signal includes an optical pickup head for generating light to form a first subordinate spot on an optical medium and a second subordinate spot on the optical medium, and detecting light reflected from the first and second subordinate spots on the optical medium to generate first and second tracking signals. A phase delay unit is coupled to the optical pickup head for delaying the first tracking signal or the second tracking signal to thereby generate a compensated tracking signal. A tracking error generator is coupled to the phase delay unit for utilizing at least the compensated tracking signal to generate a tracking error signal. Because the maximum amplitude of the tracking error signal is increased to a maximum level, the accuracy and speed of track seeking operations of the optical storage device are improved.

### BACKGROUND OF INVENTION

1. Field of the Invention

The invention relates to optical storage devices, and more particularly, to compensating for Y-ratio misalignment of an optical pickup head in an optical storage device.

2. Description of the Prior Art

FIG. 1 is an diagram illustrating a Y-ratio misalignment Yₑᵣᵣₒᵣ of an optical pickup head 102 in an optical storage device according to the related art. In FIG. 1, the optical pickup head 102 traverses along the x-axis and generates light to form a primary spot Pₛₚₒₜ, and first and second subordinate spots Eₛₚₒₜ, Fₛₚₒₜ on an optical medium 100. In the ideal situation, as the optical pickup head 102 traverses across the optical medium 100, the primary spot Pₛₚₒₜ follows along and directly over the x-axis. Because mechanical tolerances only allow for an accuracy of approximately plus/minus 0.15 micro-meters, it is not uncommon for a y-ratio misalignment Yₑᵣᵣₒᵣ to exists in optical storage devices.

FIG. 2 is a diagram illustrating the ideal positions of the primary spot Pₛₚₒₜ and the subordinate spots Eₛₚₒₜ, Fₛₚₒₜ on a track grove 200 of the optical medium 100 according to the related art. As shown in FIG. 2, the optical pickup head 102 positions the first and second first subordinate spots Eₛₚₒₜ, Fₛₚₒₜ on opposite sides of the track grove 200 and substantially on a line 202 being inline with the primary spot Pₛₚₒₜ on the optical medium 100. In the absence of Yₑᵣᵣₒᵣ, the primary spot Pₛₚₒₜ is directly over and follows along the x-axis. During tracking operations, if the three spots are on the track grove 200, subsidiary photodetectors (not shown) corresponding to the subordinate spots Eₛₚₒₜ, Fₛₚₒₜ receive equal amount of light. The subordinate spots Eₛₚₒₜ, Fₛₚₒₜ will be rather bright because they are each tracking half on land. The primary spot Pₛₚₒₜ, however, will be reduced in brightness because it is tracking on both land and pits comprising data in the track grove 200. If the optical pickup head 102 is off track, the primary spot photodetectors get more light because there are fewer pits off track, and the subordinate spot photodetectors will be misbalanced. In order to perform track seeking, a tracking error signal TE is defined as TE=E−F, where E corresponds to the amount of light received by the photodetector for the first subordinate spot Eₛₚₒₜ, and F corresponds to the amount of light received by the photodetector for the second subordinate spot Fₛₚₒₜ.

FIG. 3 is shows the generation of the tracking error signal TE for the situation shown in FIG. 2. For example, assume the optical pickup head 102 traverses in the increasing x-axis direction across the optical medium 100. In this case, the second subordinate spot Fₛₚₒₜ will first enter each track grove 200. Next, the primary spot Pₛₚₒₜ will enter, and then the first subordinate spot Eₛₚₒₜ will begin to enter. While crossing the track grove 200, at the point when the second subordinate spot Fₛₚₒₜ is half-way out of the track grove 200, the first subordinate spot Eₛₚₒₜ will be half-way into the track grove 200. In this way, the tracking error signal TE will be generated according to the formula TE=E−F as shown in FIG. 3. More particularly, as illustrated in FIG. 3, every time a track grove 200 is crossed, the tracking error signal TE goes through one period.

FIG. 4 is a diagram illustrating the positions of the primary spot Pₛₚₒₜ and the subordinate spots Eₛₚₒₜ, Fₛₚₒₜ on a track grove 200 in the presence of positive y-error according to the related art. As shown in FIG. 4, because of the positive y-ratio misalignment, the main spot Pₛₚₒₜ is no longer directly over the x-axis, and the track grove 200 appears at a slight angle to the right. Because of this, when on track, both the first and second subordinate spots Eₛₚₒₜ, Fₛₚₒₜ are both mostly positioned within the track grove 200.

FIG. 5 is shows the generation of the tracking error signal TE for the positive y-error shown in FIG. 4. Again assume the optical pickup head 102 traverses in the increasing x-axis direction across the optical medium 100. In the presence of positive y-ratio misalignment Yₑᵣᵣₒᵣ, the order of the light spots entering each track grove 200 remains the same; however, while crossing the track grove 200, the time when both subordinate spots Eₛₚₒₜ, Fₛₚₒₜ are together mostly within the track grove is increased. Therefore, although each period of the generated tracking error signal TE continues to indicate a track grove 200 crossing, the amplitude of the tracking error signal TE is reduced.

FIG. 6 is a diagram illustrating the positions of the primary spot Pₛₚₒₜ and the subordinate spots Eₛₚₒₜ, Fₛₚₒₜ on a track grove 200 in the presence of negative y-error according to the related art. As shown in FIG. 6, because of the negative y-ratio misalignment, the main spot Pₛₚₒₜ is no longer directly over the x-axis, and the track grove 200 appears at a slight angle to the left. Because of this, when on track, both the first and second subordinate spots Eₛₚₒₜ, Fₛₚₒₜ are both mostly positioned outside the track grove 200.

FIG. 7 shows the generation of the tracking error signal TE for the negative y-error shown in FIG. 6. Again assume the optical pickup head 102 traverses in the increasing x-axis direction across the optical medium 100. In the presence of negative y-ratio misalignment Yₑᵣᵣₒᵣ, the order of the light spots entering each track grove 200 remains the same; however, while crossing the track grove 200, the time when both subordinate spots Eₛₚₒₜ, Fₛₚₒₜ are together mostly outside the track grove is increased. Therefore, although each period of the generated tracking error signal TE continues to indicate a track grove 200 crossing, the amplitude of the tracking error signal TE is again reduced. The effect of positive y-error and negative y-error is to reduce the amplitude of the tracking error signal TE. This reduces the accuracy and speed of track seeking operations in the optical storage device.

According to the related art, mechanical adjustments or calibrations made to each optical storage device after manufacture are used to eliminate the y-ratio misalignment Yₑᵣᵣₒᵣ. This method can compensate the integrated Y-error caused by OPU, CDM/DVDM, and other mechanical variations. However, these labor intensive mechanical adjustments and calibrations increase the overall cost of the manufacturing process. Additionally, due to regular operation, the y-ratio misalignment Yₑᵣᵣₒᵣ may actually change over time. For example, slight vibrations or shock could cause or change the y-ratio misalignment Yₑᵣᵣₒᵣ after the optical storage device has entered regular operations.

### SUMMARY OF INVENTION

One objective of the claimed invention is therefore to provide an optical storage device capable of compensating for y-ratio misalignment when generating a tracking error signal, to solve the above-mentioned problems.

According to an exemplary embodiment of the claimed invention, an optical storage device is disclosed comprising: an optical pickup head for generating light to form a first subordinate spot on an optical medium and a second subordinate spot on the optical medium, for detecting light reflected from the first subordinate spot on the optical medium to generate a first tracking signal, and for detecting light reflected from the second subordinate spot on the optical medium to generate a second tracking signal; a phase delay unit coupled to the optical pickup head for delaying the first tracking signal or the second tracking signal to thereby generate a compensated tracking signal; and a tracking error generator coupled to the phase delay unit for utilizing at least the compensated tracking signal to generate a tracking error signal.

According to another exemplary embodiment of the claimed invention, a method of generating a tracking error signal in an optical storage device is disclosed. The method comprises the following steps: generating light to form a first subordinate spot and a second subordinate spot on an optical medium; detecting light reflected from the first subordinate spot on the optical medium to generate a first tracking signal; detecting light reflected from the second subordinate spot on the optical medium to generate a second tracking signal; delaying the first tracking signal or the second tracking signal to thereby generate a compensated tracking signal; and utilizing at least the compensated tracking signal to generate a tracking error signal.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is an diagram illustrating a Y-ratio misalignment of an optical pickup head in an optical storage device according to the related art.

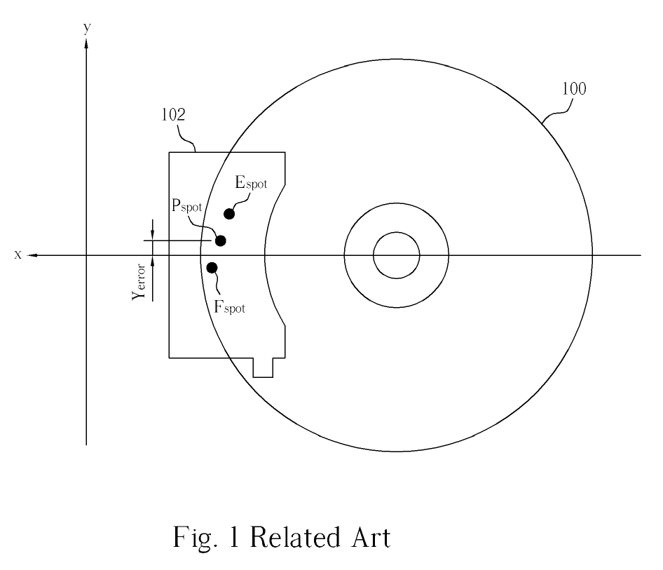

FIG. 2 is a diagram illustrating the ideal positions of the primary spot and the subordinate spots on a track grove of the optical medium of FIG. 1.

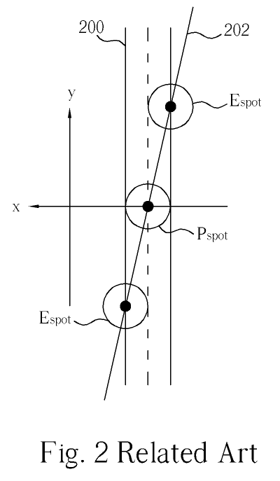

FIG. 3 is shows the generation of the tracking error signal TE for the situation shown in FIG. 2.

FIG. 4 is a diagram illustrating the positions of the primary spot and the subordinate spots on a track grove in the presence of positive y-error according to the related art.

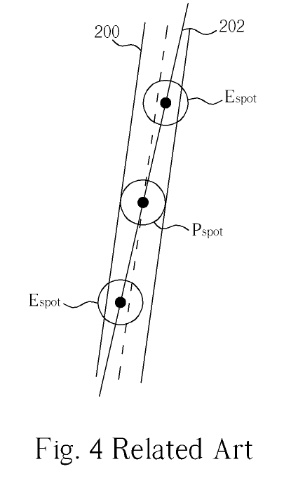

FIG. 5 is shows the generation of the tracking error signal TE for the positive y-error shown in FIG. 4.

FIG. 6 is a diagram illustrating the positions of the primary spot and the subordinate spots on a track grove in the presence of negative y-error according to the related art.

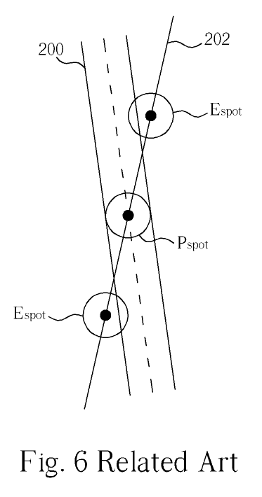

FIG. 7 is shows the generation of the tracking error signal TE for the negative y-error shown in FIG. 6.

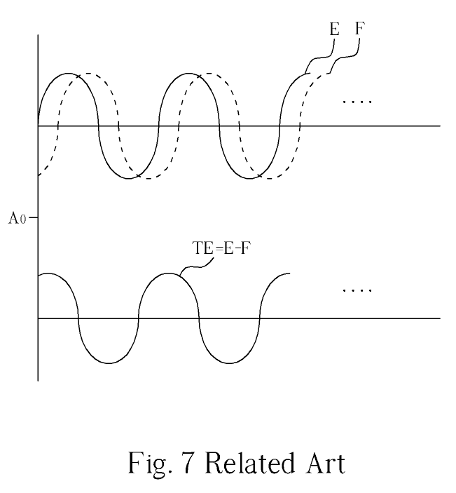

FIG. 8 is a block diagram of an optical storage device according to an exemplary embodiment of the present invention.

FIG. 9 is a signal diagram of tracking signals, compensated tracking signal, and the resulting tracking error signal according to an exemplary embodiment of the present invention.

FIG. 10 is a flowchart describing a general method of generating a tracking error signal according an exemplary embodiment of the present invention.

### DETAILED DESCRIPTION

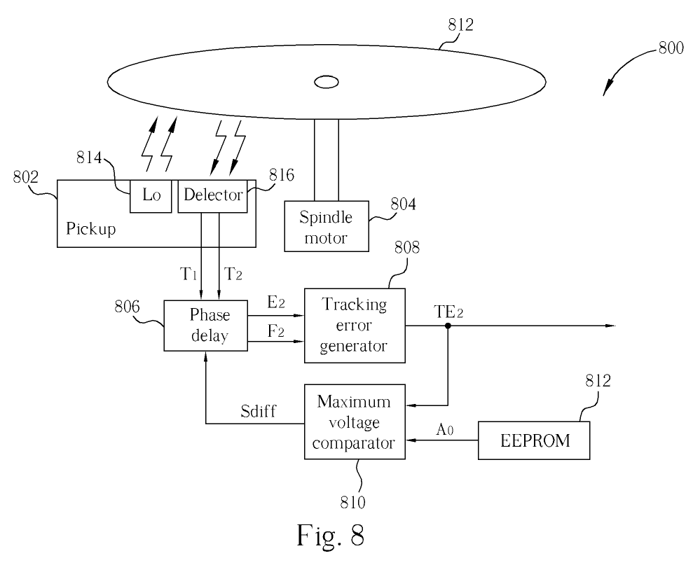

FIG. 8 is a block diagram of an optical storage device 800 according to an exemplary embodiment of the present invention. The optical storage device 800 includes an optical pickup head 802, a spindle motor 804, a phase delay unit 806, a tracking error generator 808, a voltage comparator 810, and a non-volatile memory such as an EEPROM 812. The spindle motor 804 rotates an optical medium 812 at the correct rotational velocity under control of a control unit (not shown). The optical pickup head 802 includes a laser diode 814 for generating light to form a first subordinate spot Eₛₚₒₜ and a second subordinate spot Fₛₚₒₜ on the optical medium. The optical pickup head 802 positions the first and second first subordinate spots Eₛₚₒₜ, Fₛₚₒₜ on opposite sides of a track grove 200 and substantially inline with a primary spot Pₛₚₒₜ on the optical medium 812.

As shown in FIG. 8, the optical pickup head 802 also includes an optical detector 816 for detecting light reflected from the optical medium 812 corresponding to the first subordinate spot Eₛₚₒₜ and the second subordinate spot Fₛₚₒₜ. The optical detector 816 outputs a first tracking signal T₁ corresponding to the amount of light received by the optical detector 816 for the first subordinate spot Eₛₚₒₜ, and a second tracking signal T₂ corresponding to the amount of light received by the optical detector 816 for the second subordinate spot Fₛₚₒₜ. The first and second tracking signals T₁, T₂ are coupled to the phase delay unit 806, which delays at least one of the tracking signals T₁, T₂ to generate a compensated tracking signal. For example, in this exemplary embodiment, the phase delay unit 806 delays the second tracking signal T₂ to thereby generate a compensated tracking signal F₂. The phase delay unit 806 simply passes the first tracking signal T₁ through the phase delay unit 806 with no delay to generate an E₂ signal. The tracking error generator 808 then generates a tracking error signal TE₂ according to the formula TE₂=E₂−F₂.

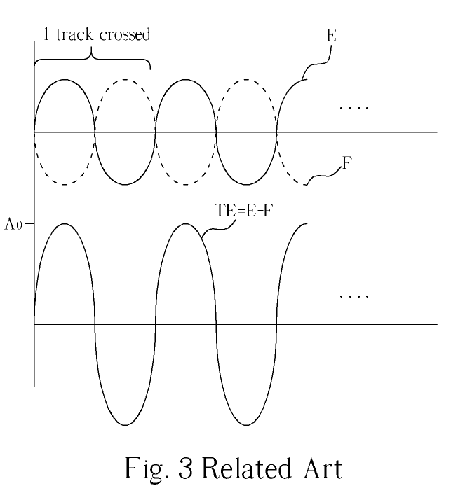

The maximum voltage comparator 810 compares the maximum level of the tracking error signal TE₂ with a predetermined maximum value A₀ stored in the EEPROM 812, and generates a difference signal S_{diff} corresponding to the difference between the maximum level of the tracking error signal TE₂ and the predetermined maximum value A₀. The predetermined maximum value is a characteristic of the optical storage device determined after the optical storage device is manufactured and corresponds to the maximum amplitude of the tracking error signal TE₂ assuming zero y-ratio misalignment Yₑᵣᵣₒᵣ. Using FIG. 3 as an example, the predetermined maximum value A₀ corresponds to the maximum value of the tracking error signal TE caused by the E and F tracking signals having a phase difference of 180 degrees. That is, in FIG. 3, when the E and F tracking signals have a phase difference of 180 degrees, the tracking error signal TE is capable of reaching its maximum amplitude. In this embodiment shown in FIG. 8, the phase delay unit 806 delays the second tracking signal T₂ by a phase delay P according to the difference signal S_{diff}. If the maximum level of the tracking error signal TE₂ generated by the tracking error generator 812 is less than the predetermined maximum value A₀, the phase delay unit 806 increases (or in another embodiment, decreases) the phase delay P accordingly.

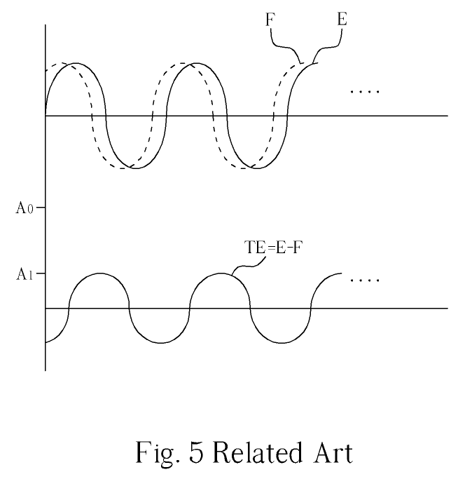

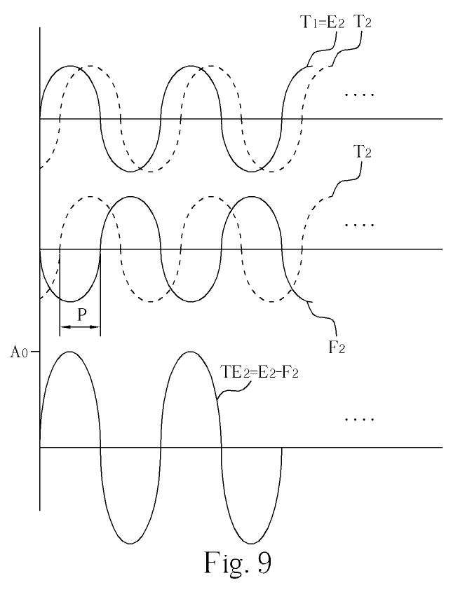

FIG. 9 is a signal diagram of first and second tracking signals T₁, T₂; the compensated tracking signal F₂, and the resulting tracking error signal TE₂ in the presence of negative y-error according to an exemplary embodiment of the present invention. As the optical pickup head 802 traverses in the increasing x-axis direction across the optical medium 812 while performing track seeking, due to the negative y-error, the second tracking signal T₂ lags behind the first tracking signal T₁. Initially, the phase delay unit 806 does not add any phase delay and therefore the E₂ signal and the F₂ signal are equal to the incoming first and second tracking signals T₁, T₂, respectively. That is, initially, the tracking error signal TE₂ generated by the tracking error generator 808 resembles the tracking error signal TE shown in FIG. 5. As shown in FIG. 5, the initial maximum value A₀ of the tracking error signal TE2 is lower than the predetermined maximum value A₀, which is stored in the EEPROM 812. Therefore, the maximum voltage comparator 810 outputs a difference signal S_{diff} to the phase delay unit 806. The phase delay unit 806 therefore increases a phase delay P to delay the second tracking signal T2 and thereby generate the compensated tracking signal F₂.

As shown in FIG. 9, when the phase difference between the compensated tracking signal F2 and the E2 signal (being directly equal to the first tracking signal T1 in this embodiment) is substantially 180 degrees, the maximum level of the tracking error signal TE2 is increased to A₀. At this point, the maximum voltage comparator 810 detects no difference between the maximum level of the tracking error signal TE₂ and the predetermined maximum value A₀ and therefore stops outputting the difference signal S_{diff}. The phase delay unit 806 therefore holds the phase difference P constant. In this way, the resulting tracking error signal TE₂ is has a maximum possible signal swing and is thereby compensated for the y-ratio misalignment according to the present invention.

As will be recognized by a person of ordinary skill in the art after reading the above description, the operation and control of the phase delay unit 806 described above is only one possible embodiment of the present invention. That is, the above description is meant as an illustration of one exemplary embodiment of the present invention and is not meant as a limitation. For example, in another embodiment, in order to increase the speed of the compensation performed by the phase delay unit 806, the difference signal outputted by the maximum voltage comparator corresponds directly to the required amount of phase delay P such that the following formula is satisfied:

$$\frac{( maximum level of the tracking error signal {TE}_{2} )}{( predetermined maximum value {A}_{0} )} = sin ( \frac{P}{2} ) \qquad Formula 1$$

In this embodiment, the phase delay unit 806 delays the second tracking signal T₂ by a phase delay P such that the phase delay P satisfies the above formula 1. The relationship shown in formula 1 ensures that the phase delay P added by the phase delay unit 806 will cause the amplitude of the tracking error signal TE₂ to increase to the predetermined maximum level A₀.

It should also be noted that other embodiments of the present invention also exist. For example, the phase delay unit 806 could delay both the first and second tracking signal T₁, T₂ to thereby generate two compensated tracking signals E₂, F₂, respectively. In another embodiment, the phase delay unit 800 could perform a direct analysis on the first and second tracking signals T₁, T₂ to determine the appropriate phase delay P needed to ensure there is a phase difference of 180 degrees between the E₂ and F₂ signals.

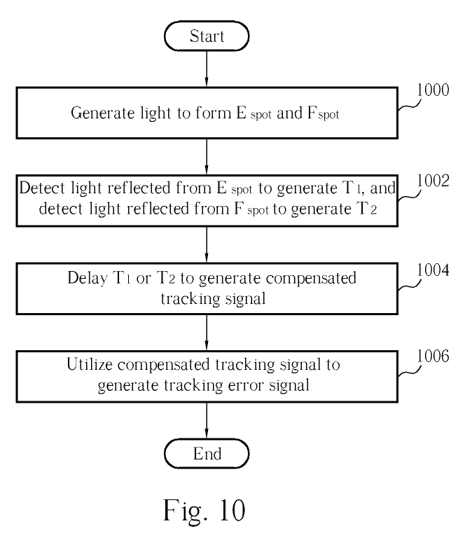

FIG. 10 is a flowchart describing a general method of generating a tracking error signal according an exemplary embodiment of the present invention and contains the following steps:

Step 1000: Generate light to form a first subordinate spot Eₛₚₒₜ and a second subordinate spot Fₛₚₒₜ on an optical medium 812.

Step 1002: Detect light reflected from the first subordinate spot Eₛₚₒₜ on the optical medium 812 to generate a first tracking signal T₁, and detect light reflected from the second subordinate spot Fₛₚₒₜ on the optical medium 812 to generate a second tracking signal T₂.

Step 1004: Delay the first tracking signal T₁ or the second tracking signal T₂ to thereby generate a compensated tracking signal. For example, as shown in FIG. 9, delay the second tracking signal T₂ by a phase delay P to thereby generate a compensated tracking signal F₂, while passing through the first tracking signal T₁ to form the E₂ signal. In another embodiment, delay the first tracking signal T₁ by a phase delay P to thereby generate a compensated tracking signal E₂, while passing through the second tracking signal T₂ to form the F₂ signal. In yet another embodiment, delay both the first and second tracking signal T₁, T₂ to thereby generate two compensated tracking signals E₂, F₂, respectively.

Step 1006: Utilize at least the compensated tracking signal generated in Step 1004 to generate a tracking error signal. For example, as illustrated in the above embodiments, two signals: E₂ and F₂ are generated as a result of step 1004, where at least one of the two signals E₂, F₂ is a compensated tracking signal having a phase delay. In this embodiment, the tracking error signal is generated according to the following formula: TE₂=E₂−F₂, where TE₂ is the tracking error signal resulting from step 1006.

The present invention provides an optical storage device capable of compensating for y-ratio misalignment when generating a tracking error signal. An optical pickup head generates light to form a first subordinate spot on an optical medium and a second subordinate spot on the optical medium, and detects light reflected from the first and second subordinate spots on the optical medium to generate first and second tracking signals. A phase delay unit is coupled to the optical pickup head and/or control IC system for delaying the first tracking signal or the second tracking signal to thereby generate a compensated tracking signal. Finally, a tracking error generator is coupled to the phase delay unit for utilizing at least the compensated tracking signal to generate a tracking error signal. According to the present invention, the maximum amplitude of the generated tracking error signal is increased to a predetermined maximum level, thereby increasing the accuracy and speed of track seeking operations of the optical storage device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical storage device comprising:
an optical pickup head for generating light to form a first subordinate spot on an optical medium and a second subordinate spot on the optical medium, for detecting light reflected from the first subordinate spot on the optical medium to generate a first tracking signal, and for detecting light reflected from the second subordinate spot on the optical medium to generate a second tracking signal;
a phase delay unit coupled to the optical pickup head for delaying the first tracking signal or the second tracking signal to thereby generate a compensated tracking signal; and
a tracking error generator coupled to the phase delay unit for utilizing at least the compensated tracking signal to generate a tracking error signal.

2. The optical storage device of claim 1, wherein the tracking error generator is further for subtracting the first tracking signal or the second tracking signal with the compensated tracking signal to generate the tracking error signal.

3. The optical storage device of claim 1, wherein the phase delay unit is further for delaying the first tracking signal or the second tracking signal such that the phase difference between the first tracking signal or the second tracking signal and the compensated tracking signal is substantially equal to 180 degrees.

4. The optical storage device of claim 1, further comprising a maximum voltage level comparator for comparing a maximum level of the tracking error signal with a predetermined maximum value, and for generating a difference signal corresponding to the difference between the maximum level of the tracking error signal and the predetermined maximum value;
wherein the phase delay unit is further for delaying the first tracking signal or the second tracking signal according to the difference signal to thereby generate the compensated tracking signal.

5. The optical storage device of claim 4, wherein the phase delay unit is further for delaying the first tracking signal or the second tracking signal by a phase delay (P) such that the following formula is substantially satisfied:
$$\frac{( maximum level of the tracking error signal )}{( predetermined maximum value )} = sin ( \frac{P}{2} )$$

6. The optical storage device of claim 4, wherein the phase delay unit is further for delaying the first tracking signal or the second tracking signal such that the maximum level of the tracking error signal is substantially equal to the predetermined maximum level.

7. The optical storage device of claim 4, further comprising a non-volatile memory for storing the predetermined maximum value.

8. The optical storage device of claim 7, wherein the predetermined maximum value is a characteristic of the optical storage device determined after the optical storage device is manufactured.

9. The optical storage device of claim 1, wherein the optical pickup is further for positioning the first and second first subordinate spots on opposite sides of a track grove and substantially inline with a primary spot on the optical medium.

10. A method of generating a tracking error signal in an optical storage device, the method comprising the following steps:
generating light to form a first subordinate spot and a second subordinate spot on an optical medium;
detecting light reflected from the first subordinate spot on the optical medium to generate a first tracking signal;
detecting light reflected from the second subordinate spot on the optical medium to generate a second tracking signal;
delaying the first tracking signal or the second tracking signal to thereby generate a compensated tracking signal; and
utilizing at least the compensated tracking signal to generate a tracking error signal.

11. The method of claim 10, further comprising subtracting the first tracking signal or the second tracking signal with the compensated tracking signal to generate the tracking error signal.

12. The method of claim 10, further comprising delaying the first tracking signal or the second tracking signal such that the phase difference between the first tracking signal or the second tracking signal and the compensated tracking signal is substantially equal to 180 degrees.

13. The method of claim 10, further comprising:
comparing a maximum level of the tracking error signal with a predetermined maximum value;
generating a difference signal corresponding to the difference between the maximum level of the tracking error signal and the predetermined maximum value; and
delaying the first tracking signal or the second tracking signal according to the difference signal to thereby generate the compensated tracking signal.

14. The method of claim 13, further comprising delaying the first tracking signal or the second tracking signal by a phase delay (P) such that the following formula is substantially satisfied:
$$\frac{( maximum level of the tracking error signal )}{( predetermined maximum value )} = sin ( \frac{P}{2} )$$

15. The method of claim 13, further comprising delaying the first tracking signal or the second tracking signal such that the maximum level of the tracking error signal is substantially equal to the predetermined maximum level.

16. The method of claim 13, further comprising providing a non-volatile memory for storing the predetermined maximum value.

17. The method of claim 14, wherein the predetermined maximum value is a characteristic of the optical storage device determined after manufacture.

18. The method of claim 10, further comprising positioning the first and second first subordinate spots on opposite sides of a track grove and substantially inline with a primary spot on the optical medium.
